(19) United States
(12) Patent Application Publication
(10) Pub. No.: US 2007/0055613 A1
(43) Pub. Date: Mar. 8, 2007

(54) Methods for locally executing stock market orders

(75) Inventor: Cyril Barthelemy, Le Plessis-Robinson (FR)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: GL Trade, a corporation of France, Paris (FR)

(21) Appl. No.: 11/508,462

(22) Filed: Aug. 23, 2006

(30) Foreign Application Priority Data
Aug. 31, 2005 (FR) 05/08916

(51) Int. Cl. G06Q 40/00

(52) U.S. Cl. 705/37

(57) ABSTRACT

A process for locally executing stock market orders in a system including an order server associated with a plurality of clients suitable for receiving orders from the clients and transmitting the orders to the stock market and receiving a global order book from the stock market, the process including a first stage for forming a local order book including registering a local order book from the plurality of clients at a level of a correspondence application associated with the order server, and a local order execution stage including generating a first order addressed to the order server for one of the local clients; for the order server, sending the order to the application; at the level of the correspondence application, detecting an opportunity for local execution of the first order as a function of the local order book and the global order book; and executing the order at the level of the correspondence application if the opportunity for local execution exists.

### RELATED APPLICATION

This application claims priority of French Patent Application No. 05/08916, filed Aug. 31, 2005, herein incorporated by reference.

### TECHNICAL FIELD

This disclosure relates to the area of tools for putting through an order in the stock market.

### BACKGROUND

Architectures and processes for simulating stock market orders are known. Such architectures are illustrated, e.g., in FIG. 1. In such an architecture, clients 3a, 3b and 3c are connected to an order server 2 that archives the orders received and sends out receipts. The orders received by clients 3a, 3b and 3c are analyzed at each passage and, in the case of an opportunity of execution, e.g., when a buy order of 500 units at 100 euros is received, when a sell order of the same 500 units at 100 euros is stored at the level of the order server, the execution of the order is simulated by sending a sell notice to the seller and a buy notice to the buyer and by canceling the server orders.

It is understood that this type of simulation does not take into account the global order book at the level of the stock market and, e.g., a user 4 who passes orders to stock market 1 without being connected to server 2 would not be taken account of in the managing of order opportunities.

It would therefore be advantageous to be able to place local orders at the level of order servers while taking into account the real content of the global order book of the stock market.

Moreover, in an architecture with three levels comprising the stock market, order servers and/or stock market content, and clients it is advantageous to execute the orders locally at the level of the servers.

This is the case in particular for the stock market broker, who thus realizes the two transactions on the broker's server and obtains a commission at the same time from the seller and the buyer.

It could therefore be advantageous to place orders locally within a global stock market.

### SUMMARY

This invention relates to a process for locally executing stock market orders in a system including an order server associated with a plurality of clients suitable for receiving orders from the clients and transmitting the orders to the stock market and receiving a global order book from the stock market, the process including a first stage for forming a local order book including registering a local order book from the plurality of clients at a level of a correspondence application associated with the order server, and a local order execution stage including generating a first order addressed to the order server for one of the local clients; for the order server, sending the order to the application; at the level of the correspondence application, detecting an opportunity for local execution of the first order as a function of the local order book and the global order book; and executing the order at the level of the correspondence application if the opportunity for local execution exists.

### BRIEF DESCRIPTION OF THE DRAWINGS

The disclosure will be better understood with the aid of the description, given below purely by way of explanation, of selected, representative aspects with reference made to the attached figures in which:

FIG. 1 illustrates an example of placing local orders in accordance with the prior art;

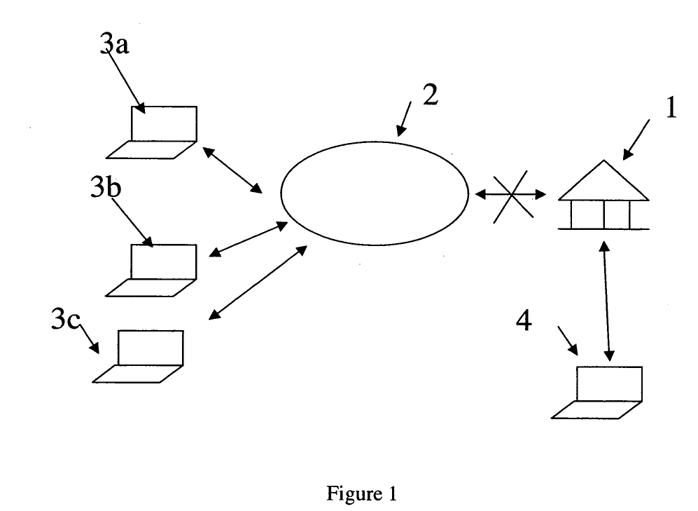

FIG. 2 illustrates an example of placing local orders in accordance with aspects of this disclosure; and

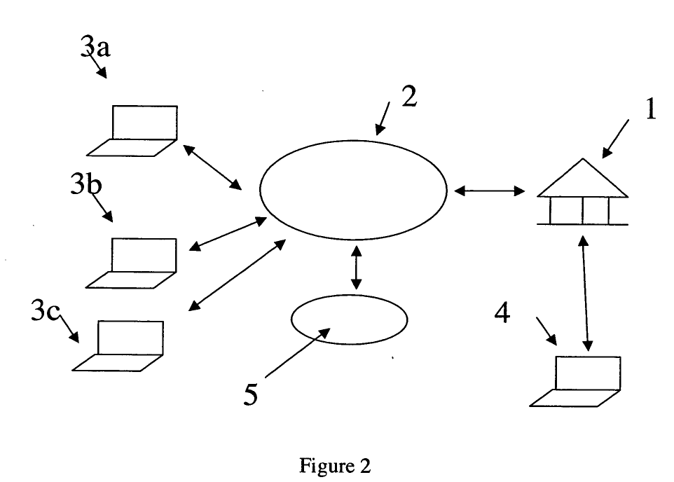

FIG. 3 is a scheme representative of selected aspects of the process.

### DETAILED DESCRIPTION

I provide processes for local execution of stock market orders in an architecture comprising an order server associated with a plurality of clients suitable for receiving orders from the plurality of clients and transmitting them to the stock market and for receiving a global order book from the stock market, which process comprises a first stage for the constitution of a local order book including registering a local order book from the plurality of clients at the level of a correspondence application (also sometimes referred to as a linking implementation) associated with the order server, and comprising a local order execution stage comprising stages:
for one of the local clients, generating a first order addressed to the order server, for the order server, sending the order to the application,
at the level of the correspondence application, detecting an opportunity for local execution of the first order as a function of the local order book and of the global order book, and
executing the order at the level of the correspondence application if the opportunity for local execution exists.

Moreover, the detection stage may comprise the following steps to take into account the global state of the market and that the client is not hurt in the local transaction:
identify a correspondence of price between a second order belonging to the local order book and the first order, and
test whether there is a better price opportunity for placing the first order at the level of the global order book.

In this case, to update the local book while remaining synchronized with the stock market, the process also comprises, in the case of the detection of an opportunity for local execution of the first order, a stage including sending a cancel order of the second order to the level of the stock market.

Moreover, the local execution stage of the first order and the second order comprises a stage including for the application in emulating an execution between the first order and the second order and in transmitting the emulated execution to the level of the order server via two transaction messages, one for each order, in such a manner as to modify the statuses of the first order and the second order.

In order to take into account partial correspondences between the entering orders and local orders, if the second order is associated with a second quantity greater than the first quantity associated with the first order the process also comprises, in the case of the detection of an opportunity for locally executing the first order, a stage including sending to the stock market level an order to reduce the quantity of the second order corresponding to the difference between the second quantity and the first quantity.

In the same manner, if the second order is associated with a second quantity lower than the first quantity associated with the first order, the process also comprises, in the case of a detection of an opportunity for locally executing the first order, a stage including sending to the level of the stock market an order corresponding to the difference between the first quantity and the second quantity.

Those skilled in the art understand that the major problem in placing local orders is to maintain a homogeneity between the global order book at the level of the stock market and the local order book at the level of the order servers. This necessitates in particular a synchronization between the order at the level of the order database and the order at the stock market level.

Moreover, if an order is executed locally, the state of the order is not modified at the stock market level when the latter no longer exists. It is therefore appropriate to rectify this problem by retaining the necessary coherence between the order server and the stock market.

It is also important to not execute local orders if the best possibilities of exchange exist on the global market so that the users are not hurt by using the put-through of local orders.

For illustrative purposes, the different orders put through are put through for a fictive instrument called I. The buy orders are designated B for Buy and the sell orders are designated S for Sell. These orders will be followed by the quantity of the buy or the sell and by the buy price and the sell price.

The instruction “I: B 500 12.00” therefore corresponds to a buy order of 500 units of the instrument I at 12.00 euros. By default, the financial instrument concerned is not mentioned and simply “B 500 12.00” is noted.

Those skilled in the art also understand that the transactions possible in a market or locally correspond to opposed orders (sell-buy) at an adapted price and for an adapted quantity.

The internal order book corresponding to the orders put through by the users of order server 2, e.g., by users 3a, 3b and 3c, and the market order book or global order book corresponding to the orders of local users 3a, 3b and 3c, but also of the rest of the users connected to the stock market, e.g., user 4, are also distinguished.

The local book is stored at the level of a correspondence application 5 associated with order server 2. Each order received at the level of order server 2 is then stored at the level of application 5 to treat possible future correspondences. Application 5 is synchronized with the order server and the local book is kept up to date as a function of the development and execution of the orders. Application 5 is an application connected to order server 2 and its client.

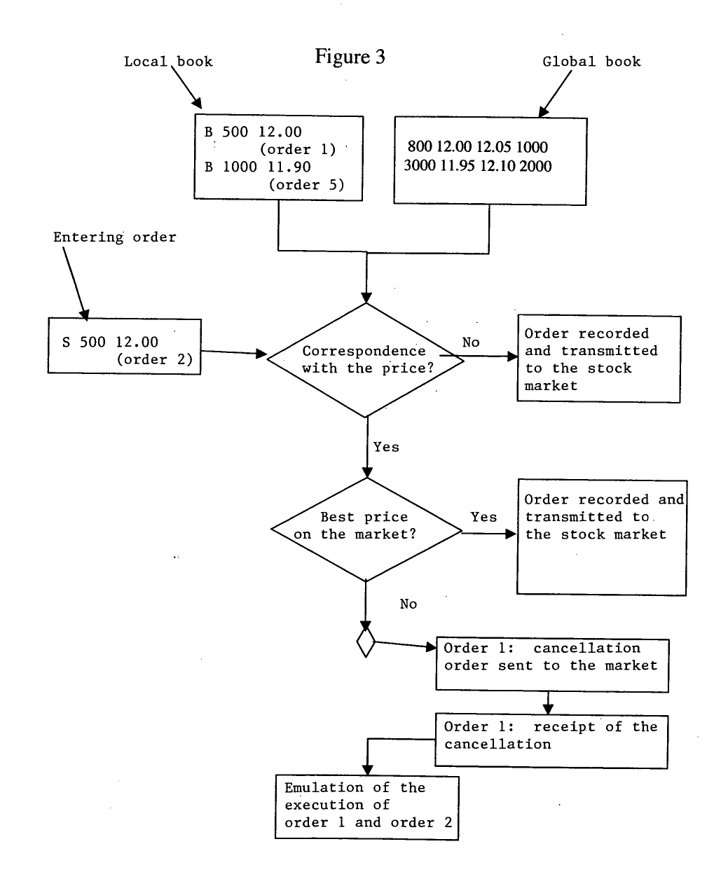

In a first example illustrated in FIG. 3, the local order book is considered for the following purchase for instrument I:

| | |
|---|---|
| B 500 | 12.00 (order 1) |
| B 1000 | 11.90 (order 5) |

and a global order book at the level of the stock market:

| | |
|---|---|
| 800 | 12.00 |
| 3000 | 11.95 |
| 2000 | 11.90 |
| 1000 | 11.85. |

The global order book of the stock market can be accessed via a flow server connected to or associated with the order server within a globally referenced platform 2.

When the server receives a sell order from one of local users 3a, 3b or 3c, e.g., S 500 12.00 (order 2), a first stage of the process determines whether there is the possibility of correspondence between a local buy order and the latter order.

The correspondence is acquired if the sell price for an instrument corresponds to a buy order for the same instrument for the same quantity.

It is understood that the process is also applicable if the quantity offered for buy is lower than the sell order, but that aggregation of several buy orders at the same price allows the quantity to be sold to be obtained.

If this is not the case, the first sell order is recorded at the level of application 5 then transmitted to stock market 1.

A test is then made whether there is a better price in the global market for realizing the transaction. This thus lets the user not be hurt by a local realizing of the transaction rather than in the global market.

The best price term depends, of course, on the type of order put through. If the order server receives a sell order entering at a price at, e.g., 17 and if there is a buy order at 20 in the global book, the transaction can then be realized at a price of 20. In this instance, it is therefore necessary that the order entering at 17 is transmitted to the market.

On the contrary, for a buy order at 17, if there is a sell order at 14 in the global book, the transaction could be realized at 14 at the level of the market.

For illustrative purposes, a better price at the stock market level is therefore a buy price at the stock market level strictly greater than the price of an entering sell offer, or a sell price at the stock market level that is strictly lower than the price of an entering buy order.

If there is no better price in the global market and if the price of the entering buy or sell order corresponds to a price for an opposed order that allows a transaction to be made, it is then considered that there is an opportunity for putting through an internal order at the level of server 2 and of application 5.

It is thus now possible to execute orders internally, but by taking care to maintain synchronization with the global order book.

To do this, a beginning is made by canceling at the stock market level the order associated with the transaction opportunity (in our example order 1). In fact, if this cancellation is not realized before the execution of the internal order, it is possible that the stock market transaction is initiated for this order that is then no longer available in the market and consequently no longer available at the level of the order server for permitting a local execution.

In the instance of a quantity obtained by the aggregation of several orders, the cancellation orders are put through for the entirety of the orders concerned.

When order server 2 receives the receipt for the cancellation of order 1, the transaction is then made by sending a sell notice to the issuer of the sell offer and a buy notice to the issuer of the buy offer.

The local execution corresponds to an emulation by the order server of an execution by the stock market. The order server sends the messages for the execution of orders to the level of application 5 in such a manner as to modify the status of the orders executed. The local order book of the application is thus synchronized at every instant with the order server.

In this manner a transaction has been made between two users of server 2 while taking account of the situation at the stock market level, in particular, by testing whether there is a better price in the market and by canceling the order before its local execution.

Following this execution, the situation at the level of the order server is therefore the following:

B 1000 11.90 (order 5) and at the level of the stock market for the global order book:

300 12.00

3000 11.95

2000 11.90

1000 11.85.

According to a second example, it is also possible to make local transactions for multiple correspondences.

This time, a local order book is considered containing, e.g., two distinct buy orders corresponding to an entering sell order. The local order book thus contains:

B 500 12.00 (order 1)

B 500 12.00 (order 4)

B 100011.90 (order 5).

The global book contains, e.g.,

1300 12.00

3000 11.95

2000 11.90

1000 11.85

Finally, an entering sell order is considered:

S 800 12.00 (order 2).

As above, a beginning is made by testing whether there is a possibility of correspondence between the entering order and the local book.

If there is such a possibility, a test is then made whether there is a better price in the market.

If such a better price does not exist, there is then an opportunity for putting through an internal order at the level of server 2 and of application 5.

In this instance, order 1 is canceled and order 4 is reduced by canceling and replacing it with an order corresponding to the remainder of the sell order relative to order 1. In the example cited, a new buy order B 200 12.00 is thus created.

To do this, confirmation of the cancellation of order 1 by the stock market is waited for and the transaction between order 1 and the corresponding quantity of order 2 is executed locally. To this end a buy notice of 500 units is sent to the buyer and a sell notice of 500 units to the seller.

The local book is updated and thus becomes:

B 500 12.00 (order 4)

B 1000 11.90 (order 5)

and the global book becomes:

800 12.00

3000 11.95

2000 11.90

1000 11.85.

Upon receiving the notice of the cancellation of order 4, a new order is then created corresponding to an order B 200 12.00. This order is sent to the stock market.

When this new order is received (which corresponds to the creation of a new order 6 relative to old order 4) it is stored at the level of the order server and the correspondence application and a sell notice for a quantity of 300 is sent to the seller and a buy notice of 300 to the buyer who issued order 4.

The new local order book is therefore:

B 200 12.00 (order 6)

B 100011.90 (order 5)

and the global book is:

500 12.00

3000 11.95

2000 11.90

1000 11.85.

This corresponds to execution of the local sell order spread between the two buy orders 1 and 4.

In the same manner, if the entering order corresponds, e.g., to a sell order S 2000 12.00 and if the local book contains an opposed buy order for a lower quantity B 1000 12.00, the sell order is partially executed locally by canceling the buy order and transmitting to the stock market a sell order corresponding to the remainder, here S 1000 12.00.

In the examples above, it is important to take into account events occurring at the level of the stock market for an order of the local book, in particular, not to emulate a local execution for an order that no longer exists in the market.

To do this, if, for example, prior to receiving a cancellation order in the process, the order for which the cancellation requested has been executed, the stock market will then reject the cancellation request.

When the stock market sends the global execution notice to the level of the order server, the latter transmits this execution to application 5, that then updates the status of the local book and, in the case of total execution, searches new opportunities for local executions.

Of course, other examples can be implemented by one skilled in the art from the examples described above.

1. A process for locally executing stock market orders in a system comprising an order server associated with a plurality of clients suitable for receiving orders from the clients and transmitting the orders to the stock market and receiving a global order book from the stock market, the process comprising:
a first stage for forming a local order book including registering a local order book from the plurality of clients at a level of a correspondence application associated with the order server; and
a local order execution stage comprising:
generating a first order addressed to the order server for one of the local clients,
for the order server, sending the order to the application,
at the level of the correspondence application, detecting an opportunity for local execution of the first order as a function of the local order book and the global order book, and
executing the order at the level of the correspondence application if the opportunity for local execution exists.

2. The process according to claim 1, wherein the detecting comprises:
identifying a correspondence of price between a second order belonging to the local order book and the first order, and
testing whether there is a better price opportunity for placing the first order at the level of the global order book.

3. The process according to claim 2, further comprising, when detecting an opportunity for local execution of the first order, sending a cancellation order of the second order to the level of the stock market.

4. The process according to claim 2, wherein the local execution of the first order and the second order comprises emulating an execution of the first order and the second order and transmitting the emulated execution to the level of the correspondence application to modify status of the first order and of the second order.

5. The process according to claim 2, wherein the second order is associated with a second quantity greater than the first quantity associated with the first order and further comprises, when detecting an opportunity for locally executing the first order, sending to the stock market level an order to reduce the quantity of the second order corresponding to a difference between the second quantity and the first quantity.

6. The process according to claim 2, wherein the second order is associated with a second quantity lower than the first quantity associated with the first order and further comprises, when detecting an opportunity for locally executing the first order, sending to the level of the stock market an order corresponding to a difference between the first quantity and the second quantity.

7. A process for locally executing stock market orders, comprising:
establishing a local order book by registering a local order book from a plurality of clients at a link adapted to communicate with an order server associated with the plurality of clients suitable for receiving orders from the plurality of clients and transmitting the orders to a stock market and for receiving a global order book from the stock market, and
locally executing orders by:
generating a first order addressed to the order server for a local client,
sending the order to the link,
detecting an opportunity for local execution of the first order as a function of the local order book and global order book at the link, and
executing the order at the link if the opportunity for local execution exists.
